(19) United States
(12) Patent Application Publication
(10) Pub. No.: US 2011/0001041 A1
(43) Pub. Date: Jan. 6, 2011

(54) METHOD AND APPARATUS ALLOWING QUANTITATIVE INVESTIGATIONS OF ORGANIC AND INORGANIC SAMPLE BY DECOUPLING THE SPUTTERING PROCESS FROM THE ANALYSIS PROCESS

(76) Inventors: Henri-Noël Migeon, Tuntange (LU); Tom Wirtz, Grevenmacher (LU); Georges Slodzian, Sceaux (FR)

Correspondence Address: MERCHANT & GOULD PC, P.O. BOX 2903, MINNEAPOLIS, MN, 55402-0903, US

(21) Appl. No.: 12/681,583

(22) PCT Filed: Oct. 9, 2008
(86) PCT No.: PCT/EP08/63549

§ 371 Date: Sep. 21, 2010

Related U.S. Application Data
(60) Provisional application No. 60/979,171, filed on Oct. 11, 2007.

(51) Int. Cl. H01J 49/26; G01N 23/225; G01N 23/00; G01N 23/223

(52) U.S. Cl. 250/282; 250/307; 250/306; 378/44

(57) ABSTRACT

A method and an analytical instrument are for quantitative investigations of organic and inorganic samples using the Secondary Ion Mass Spectromy (SIMS) technique. The sputtering process is decoupled from the analysis process.

### FIELD OF THE INVENTION

The present invention relates to a method for quantitative investigations of organic and inorganic samples and relates also to an analytical instrument for carrying out said quantitative investigations.

### PRIOR ART AND RELATED TECHNICAL BACKGROUND

Among surface analysis techniques, Secondary Ion Mass Spectrometry (SIMS) is a well-established and widely used technique.

The SIMS technique is based on the detection of secondary ions emitted by a sample exposed to a primary ion bombardment produced by a focused beam of ions, typically Cs⁺, Ga⁺, Ar⁺, O⁻ or O₂⁺. The ion emission produced by the sample following the primary ion bombardment, also called sputtering phenomenon, which is a characteristic of the material itself, is then analysed by mass spectrometry.

Owing in particular to its excellent sensitivity, its high dynamic range and its good depth resolution, SIMS is an extremely powerful technique for analyzing samples. However, SIMS has an important drawback due to the fact that this technique uses the ionized part of the emitted flux from the sample. This drawback is known as the “matrix effect” which is a quantification problem due to the fact that the ionisation probability of atoms and molecules emitted from the sample strongly depends on the sample composition. For metallic samples or for semi-conductors for instance, the ionization probability for positive and negative ions is exponentially depending on the electron work function of the sample (“electron tunnelling model”). As a consequence, the intensity of the measured signals is also greatly depending on the composition of the analysed sample.

### AIMS OF THE INVENTION

The present invention aims to provide an analytical method and instrument which do not have the drawbacks of the prior art.

Particularly, the invention aims to provide an analytical method and instrument which are sensitive and which allow quantification.

### SUMMARY OF THE INVENTION

The present invention relates to a method for analysing an inorganic or organic sample under ultra-high vacuum, comprising the steps of:
a) providing under ultra-high vacuum at least one sample to be analysed;
b) providing under ultra-high vacuum at least one collector;
c) submitting said sample to an ion or neutral bombardment;
d) collecting on said collector particles emitted by said bombarded sample;
e) analysing the collected particles on said at least one collector;
   said steps being performed so that the emission of sample particles is decoupled of the analysis step.

According to particular embodiments, the present invention may comprise one or a combination of any of the following characteristics:
before step c), a cleaning step of the collector is performed by an etching ion gun, operated with noble gas ions, cluster ions, metallic ions or neutrals;
before step c), a step of treating the collector is performed, said treating step comprising either the oxidation, or the coating, or both, of the surface of the collector;
the surface of the collector is either oxydized, or coated with a layer made of one or more elements, or both, said elements being selected from the group consisting of aluminum (Al), arsenic (As), barium (Ba), beryllium (Be), bismuth (Bi), cadmium (Cd), caesium (Cs), calcium (Ca), carbon (C), cerium (Ce), cobalt (Co), copper (Cu), gadolinium (Gd), gallium (Ga), germanium (Ge), gold (Au), hafnium (Hf), indium (In), iridium (Ir), lanthanum (La), lead (Pb), lithium (Li), lutetium (Lu), manganese (Mn), magnesium (Mg), molybdenum (Mo), neodymium (Nd), nickel (Ni), osmium (Os), palladium (Pd), platinum (Pt), potassium (K), rhenium (Re), rhodium (Rh), rubidium (Rb) ruthenium (Ru), samarium (Sa), scandium (Sc), silicon (Si), silver (Ag), sodium (Na), strontium (Sr), tantalum (Ta), tellurium (Te), terbium (Tb), thallium (Tl), thorium (Th), tungsten (W), uranium (U), yttrium (Y), and zirconium (Zr);
the treating step of the collector is performed by Physical Vapor Deposition (PVD), Electron Beam Physical Vapor Deposition (EBPVD), Molecular Beam Epitaxy (MBE) or Rapid Thermal Processing (RTP);
the collector is made of an organic material or a metal or a semi-conductor material;
the ion bombardment is a monoatomic ions, a cluster ions bombardment or a neutral bombardment;
collector, the sample, or both, are moving during steps c) and/or d);
a first analytical instrument used to perform step c) and d), and a second analytical instrument used to perform step e), are located in remote places;
step e) is performed by an analytical method selected from the group consisting of static SIMS (Secondary Ion Mass Spectrometry), dynamic SIMS, LEIS (Low-Energy Ion Scattering), RBS (Rutherford Back Scattering), XPS (X-ray Photoelectron Spectroscopy), AES (Auger Electron Spectroscopy), UPS (Ultraviolet Photoelectron Spectroscopy), electron microprobe, and Total X-Ray Fluorescence;

The present invention relates also to an analytical instrument operating under ultra-high vacuum comprising at least one collector for collecting the secondary particles emitted during an ion or neutral bombardment of a sample to be analysed.

According to particular embodiments, the analytical instrument may comprise one or a combination of any of the following characteristics:
the collector, or the sample, or both, are movable in any direction;
a diaphragm with a circular aperture is disposed in front of the collector, preferably at a distance of about 2 mm from the collector, so that to limit the exposed surface of the collector to the particles emitted from the sample, preferably to a diameter of 500 μm;
the collector comprises a one inch wafer made of an organic material, or a metal or a semi-conductor material;
the analytical instrument is provided with means for either oxydizing, or coating with a layer made of one or more elements, the surface of the collector (5), or both, said elements being selected from the group consisting of aluminum (Al), arsenic (As), barium (Ba), beryllium (Be), bismuth (Bi), cadmium (Cd), caesium (Cs), calcium (Ca), carbon (C), cerium (Ce), cobalt (Co), copper (Cu), gadolinium (Gd), gallium (Ga), germanium (Ge), gold (Au), hafnium (Hf), indium (In), iridium (Ir), lanthanum (La), lead (Pb), lithium (Li), lutetium (Lu), manganese (Mn), magnesium (Mg), molybdenum (Mo), neodymium (Nd), nickel (Ni), osmium (Os), palladium (Pd), platinum (Pt), potassium (K), rhenium (Re), rhodium (Rh), rubidium (Rb) ruthenium (Ru), samarium (Sa), scandium (Sc), silicon (Si), silver (Ag), sodium (Na), strontium (Sr), tantalum (Ta), tellurium (Te), terbium (Tb), thallium (Tl), thorium (Th), tungsten (W), uranium (U), yttrium (Y), zirconium (Zr);
the analytical means are selected in the group consisting of static SIMS (Secondary Ion Mass Spectrometry), dynamic SIMS, LEIS (Low-Energy Ion Scattering), RBS (Rutherford Back Scattering), XPS (X-ray Photoelectron Spectroscopy), AES (Auger Electron Spectroscopy), UPS (Ultraviolet Photoelectron Spectroscopy), electron microprobe, and Total X-Ray Fluorescence;
the analytical instrument comprises the following main sections, all under ultra-high vacuum:
   optionally, a docking station or chamber, able to fit a transfer vessel for transferring the collector, possibly mounted on a holder, between the instrument and said transfer vessel;
   a cleaning section for cleaning the collector, preferably equipped with a sputter gun allowing ion etching;
   a coating and preparation section, for preparing and surface oxydising and coating the collector, preferably equipped with effusion cells, an electron beam evaporator, quartz microbalances, a Reflection High Energy Electron Diffraction (RHEED) and/or a Residual Gas Analyser (RGA);
   a sputter-deposition section for sputtering the sample and further depositing the sputtered particles onto the collector, equipped with an ion gun, preferably being of the Floating Low-Energy Ion Gun (FLIG) type, a secondary electron detector allowing a visualization of the sputtering ion beam and two motorized high precision stages for the sample and the collector respectively;
      the transfer of the collector between the different sections being made using handling means and a transfer tube connected under ultra-high vacuum to all said sections;
the analytical instrument comprises an analysis section, for analysing the material collected on the collector surface.

### SHORT DESCRIPTION OF THE DRAWINGS

FIG. 1 is a schematic representation of a classic SIMS analysis.

FIG. 2 is a schematic representation of the deposition of sample particles on a collector according to the present invention.

FIG. 3 is a schematic representation of the analysis of the sample particles deposited onto the collector according to the present invention.

FIG. 4 is a schematic representation of a first preferred embodiment according to the present invention.

FIG. 5 is a schematic representation of a second preferred embodiment according to the present invention.

FIG. 6 is a schematic representation of the analytical instrument according to the present invention.

FIG. 7 represents an example of the sensitivity of the method characterised by the useful yield in respect to the number of sputtered atoms, for a number of metal elements.

FIG. 8 represents a static SIMS spectrum of the collector after a PVC deposit recorded with positive secondary ions.

FIG. 9 represents a static SIMS spectrum of the collector after a PS deposit recorded with positive secondary ions.

### DETAILED DESCRIPTION OF THE INVENTION

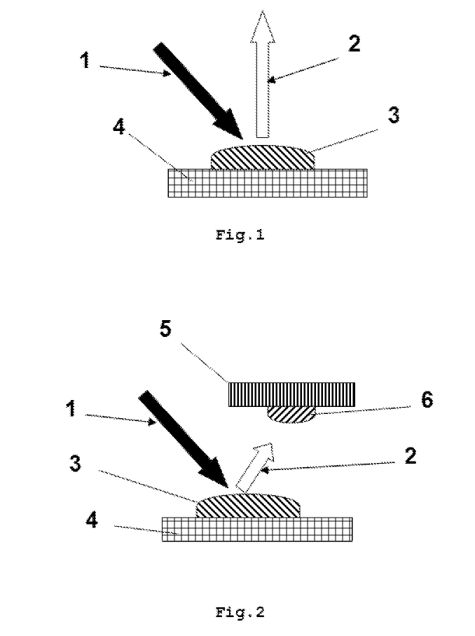

As represented in FIG. 1, in Secondary Ion Mass Spectrometry (SIMS) analysis, following the primary ion bombardment 1, the secondary particles 2 (atoms, molecules, or ions) emitted (or sputtered) from the sample 3 to be analysed, which is placed on a sample holder 4, are directly analysed by mass spectrometry.

The originality of the present invention lies in decoupling the emission of particles by the sample, from the analysis step (FIGS. 2 and 3).

According to the present invention, the particles 2 emitted under the impact of an ion or neutral bombardment 1 are deposited on a collector 5 under ultra-high vacuum (UHV) conditions, as represented in FIG. 2. Then, in a second step (FIG. 3), the collected particles 6 (deposited matter) on the collector 5 are analysed by any suitable analytical instrument, using any suitable technique, for example static SIMS, dynamic SIMS, LEIS (Low-Energy Ion Scattering), RBS (Rutherford Back Scattering), XPS (X-ray Photoelectron Spectroscopy), AES (Auger Electron Spectroscopy), UPS (Ultraviolet Photoelectron Spectroscopy), electron microprobe, Total X-Ray Fluorescence.

Preferably, the analysis is performed in a dedicated instrument which may or may not be located in the same laboratory, and which may, or may not, be a part of a more complex instrument comprising a plurality of instruments performing the steps of the method according to the present invention.

Two important points in this technique are the cleanliness and the preparation of the collector 5 surface (for example optimisation by deposition of metal films by evaporation, by oxidation, etc.).

The preparation of the collector 5 combined to a very diluted deposition of matter 6 corresponds to the creation of a new well-defined matrix which is chosen with respect to the subsequent analysis parameters (elements to be analysed, analysis mode, etc.).

On the one hand, depositing the matter sputtered 2 from different samples or from different layers of a sample 3 on a same collector 5 makes this method a powerful tool to circumvent the previously mentioned matrix effect in SIMS. As a matter of fact, the subsequent analyses are performed in a same and well-defined matrix instead of different matrixes of changing and unknown composition

On the other hand, the optimization of the collector 5 surface allows an enhancement of the yields of the subsequent analysis. In the particular case of using SIMS for this subsequent analysis of the collector 5, enhanced secondary ion emission can be obtained in the different SIMS analysis modes by well-choosing the collector 5 surface and thus the matrix with respect to the elements to be analysed and the analysis mode (positive secondary ions, negative secondary ions, organic information). The main concept of the collector treatment is to change the chemical state of the collector 5 surface, which modifies the matrix on which the deposition is done and influences significantly the secondary ion emission.

The main advantage of the invention is to permit to achieve quantification while maintaining high analysis sensitivities, for both organic and inorganic samples, and/or to increase the sensitivity of the analysis, for both organic and inorganic samples. Furthermore, as the primary bombardment 1 is decoupled from the analysis, the primary ion or neutral bombardment conditions (impact energy, incidence angle, etc.) can be freely chosen and can thus be optimized, for example for an optimum depth resolution.

The useful yield (UY) of the method according to the invention is defined by the ratio between the total counts of a given element “M” detected during the analysis of the collector 5 and the number of atoms “M” initially sputtered from the sample 3. UY depends on both steps of the method, i.e. the sputter-deposition process and the analysis, and can be written as follows:

UY=γ·UY_{Analysis} (Equ. 1)

The factor γ is depending on the sputter-deposition process and is composed of the ratio of sputtered particles reaching the collector 5 with respect to the total number of sputtered particles and of the sticking efficiency on the collector 5. UY_{Analysis} is the useful yield of the analysis of the collector 5. High values of UY_{Analysis} are achieved, as already mentioned, by optimising the surface of the collector 5 and thus increasing the yield of the subsequent analysis. In the particular case of a SIMS analysis of the collector 5, the collector surface will be chosen with respect to the nature of the elements to be analysed and the analysis mode (positive secondary ions, negative secondary ions, organic information) in order to increase the ionisation efficiency.

As a consequence, the initial loss of sensitivity due to an incomplete collection of sputtered matter 2 (γ<1) and the fact that only a fraction of the deposited matter 6 is used can be compensated.

As mentioned, the ion or neutral bombardment 1, used for the sputtering of the sample 3, can be freely chosen. It may be a monoatomic ions or cluster ions bombardment or a bombardment with neutrals. This bombardment 1 can advantageously be performed using an ion beam having an extremely low energy, thus improving the depth resolution.

In a preferred embodiment, the collector 5 is mobile, for example as shown in FIG. 4. The movement of the collector 5 may be a translation in any direction, or a rotation. Furthermore, this movement may be continuous or sequential during the collection of the secondary particles 2. This movement allows to properly position the collector 5 with respect to the preferred direction of particles 2 sputtered from the sample 3. Furthermore, this movement allows to keep sub-monolayer deposition levels as the flux of the collected particles 6 constantly deposits on virgin collector areas. Moreover, it allows to record depth profiles of the sample 3 by depositing the matter sputtered 2 from different depths of the sample 3 at different and separate locations and thus by transforming in-depth information into lateral information.

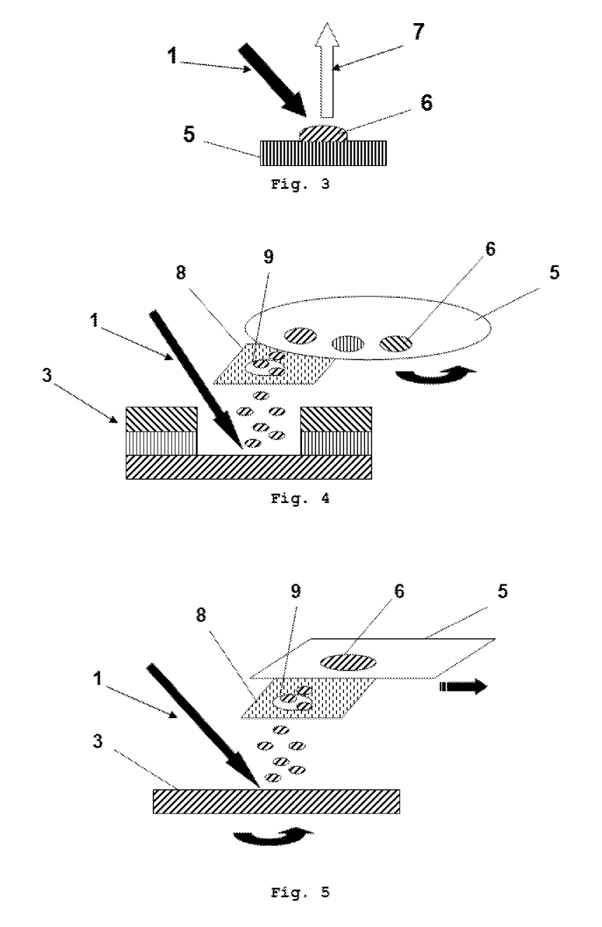

In another preferred embodiment (FIG. 5), the sample 3 and/or the collector 5 may be mobile, and are moving during the analysis, in any direction, preferably laterally or in rotation, independently one from the other.

In another particular embodiments, the collector 5 may comprise the particles from different layers of a same sample, or particles from different samples, or particles from different layers of different samples.

The collector 5 used to collect sputtered matter 2 from the sample 3 to be analyzed, may have any suitable shape. Preferably, it has the shape of a plate. Furthermore, it can be made of any suitable material, for example made an organic material, or made of metal or semi-conductor. It is preferably a one inch wafer, still ore preferably made of silicon or germanium, more preferably of high purity.

Preferably, the collector 5 is mounted on a collector holder under clean conditions, said holder being designed to fit on all instruments used throughout the process according to the invention.

Preferably, the collector 5 is positioned with a high precision motorised stage (x, y, z, rotation) at a distance of around 2 mm in front of the sample surface. A diaphragm plate 8 comprising a circular aperture 9, mounted for example 100 μm in front of the collector surface, limits the exposed surface of the collector 5, for example to a diameter of around 500 μm.

To take into account the nature of the particles 2 to be collected, the collector 5 may be treated to change the chemical state of the collector 5 surface, which thus modifies the matrix on which the deposition of the particles 2 to be collected is performed. The collector 5 surface may be oxidized, or may be coated with one or more elements, said elements may be then oxidized or not. Thus, the collector 5 surface may have a high work function for the enhancement of positive secondary ion emission, or a low work function for the enhancement of negative secondary ion emission, or the surface may be coated with gold or silver to produce a cationisation for organic information.

Elements which can be chosen for the collector 5 in general, or for the collector 5 surface in particular, owing to their high work function are, for example: platinum (Pt), iridium (Ir), tungsten (W), nickel (Ni), palladium (Pd), rhenium (Re), gold (Au), germanium (Ge), cobalt (Co), carbon (C), rhodium (Rh), beryllium (Be), tellurium (Te), silicon (Si), osmium (Os), ruthenium (Ru), copper (Cu) and molybdenum (Mo). Other elements which can be chosen for the collector in general or for the collector surface in particular owing to their low work function are, for example: tantalum (Ta), silver (Ag), aluminum (Al), lead (Pb), bismuth (Bi), cadmium (Cd), indium (In), manganese (Mn), zirconium (Zr), gallium (Ga), hafnium (Hf), arsenic (As), magnesium (Mg), uranium (U), thallium (Tl), lanthanum (La), scandium (Sc), thorium (Th), lutetium (Lu), neodymium (Nd), gadolinium (Gd), yttrium (Y), terbium (Tb), cerium (Ce), lithium (Li), calcium (Ca), sodium (Na), samarium (Sa), barium (Ba), strontium (Sr), potassium (K), rubidium (Rb) and caesium (Cs).

The oxidation, the coating, or the oxidation of coated collector surface, may be performed by any suitable method. Preferably, it is done by Physical Vapor Deposition (PVD), Electron Beam Physical Vapor Deposition (EBPVD), Molecular Beam Epitaxy (MBE) or Rapid Thermal Processing (RTP).

Preferably, before the oxidation or the coating of its surface, the collector 5 is cleaned. To avoid pollutants or impurities that could give mass interferences with the secondary particles deposit, the collectors 5 are prepared and cleaned prior to their use. The first cleaning and preparation of the collectors occurs in a clean room. In this way pollution (contaminants, dust) are minimised. Preferably, a cleaning protocol, close to those used in microelectronics, is used. For example, in a clean room (ISO Class 4) and under a laminar flow hood, the wafer is cleaned with acetone, ethanol and rinsed with demineralised water. The wafer is then dried by an N₂-air gun or in a clean room oven, which is equipped by an HEPA filter.

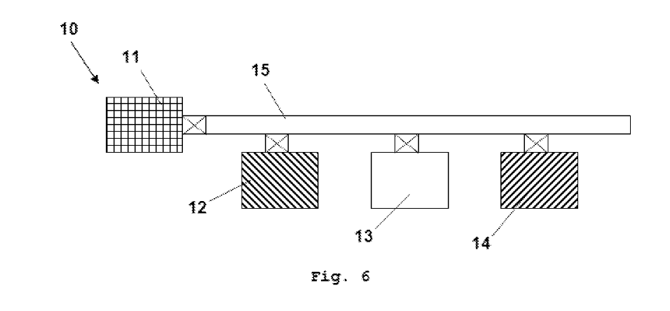

As schematically shown on FIG. 6, the analytical instrument 10 according to the invention comprises three main sections. In the first section the cleaning and the preparation of the collector 5 take place, in the second section the sputter-deposition of the sample material on the collector 5 is performed, and the third section correspond to the transfer of the collector 5 inside the instrument itself and to the subsequent analytical instruments. This arrangement allows to perform all the steps of the method according to the invention in dedicated separate chambers under optimized conditions.

All the sections of the analytical instrument 10 are under Ultra High Vacuum (UHV). In order to obtain sensitive reproducible results, the materials should be free of contamination, hence the use of UHV. The UHV may be created by any suitable means, for example by turbomolecular pumps and ion getter pumps.

The analysis of the material collected 6 on the collector 5 surface is either done in the instrument 10 according to the invention itself or in an independent analytical instrument. In the latter case, the collector 5 will be transferred under vacuum conditions between the instrument 10 and independent analytical instrument. Thus, the analytical instrument 10 may further comprise any suitable docking station 11, or chamber, fitting any collector transfer vessel or transfer system, allowing to transfer the collector 5 between the instrument 10 and the transfer vessel. Preferably, the docking station is designed to fit a UHV transfer system comprising the collector 5, or the sample holder 4 comprising the sample 3 to analyse, or both.

The analysis instrument 10 comprises collector handling means to transfer the collector 5 from one section of the analytical instrument to another section, for example from the cleaning and treating chamber to the sputter-deposition chamber. The handling means may comprise transfer rods and carriers moving on rails inside the vacuum tubes.

The collector 5 is cleaned from any contaminations in a dedicated UHV chamber 12, equipped with a sputter gun allowing an ion etching of the collector 5 surface. The sputter gun may be operated with any suitable ions comprising noble gas ions (for example Ar⁺, Xe⁺), cluster ions (for example C₆₀⁺, Arₙ⁺), or metallic ions or with neutrals.

The collector 5 is then transferred into a coating chamber 13 where it is prepared and its surface is oxidised or coated. Preferably, the coating chamber 13 is equipped with effusion cells, an electron beam evaporator, quartz microbalances, a Reflection High Energy Electron Diffraction (RHEED) and/or a Residual Gas Analyser (RGA). Preferably, the working pressure in the chamber is 10⁻¹⁰ mbar.

The cleaned and treated collector 5 is then transferred under UHV to the sputter-deposition chamber 14, in which the sputtering of the sample 3 and further the deposition of the sputtered particles 2 on the collector 5 are performed. The transfer is made using sample handling means and a transfer tube 15.

The sputter-deposition chamber 14 is preferably equipped with an ion gun, preferably being of the Floating Low-Energy Ion Gun (FLIG) type, a secondary electron detector allowing a visualization of the sputtering ion beam and two motorized high precision stages for the sample and the collector respectively.

The analytical instrument 10 comprises means to move or rotate the collector 5 or the sample 3, or both, in any direction during the analysis process. These means may comprise motorized high precision sample holder 4 and collector stages.

The process and the instrument according to the present invention may be used for the analysis of any organic and inorganic material, for example material used or produced in the semiconductor industry, but also in all industries using coatings or surface.

### EXAMPLES

### Example 1

### Inorganic Samples

The sputtering of a Ge sample by O₂⁺ ions was used as a model system to study the impact of using different collector 5 surfaces (W, Ta, Al) on the useful yield of the method according to the invention.

In order to study the influence of the collector 5 surface on the useful yield, two elements with low work function, tantalum (Ta) and aluminium (Al), and one element with high work function, tungsten (W) were chosen.

Thin films of the mentioned elements were deposited on a one inch Si wafers by electron beam physical vapour deposition (EB-PVD) from different metal pellets (Lesker, 99.999%) in a ultra-high vacuum chamber (base pressure <10⁻⁸ mbar). The distance between the source and the substrate was about 60 cm in order to achieve uniform thickness of the deposits. No extra heating was applied. The deposition rate and the film thicknesses were controlled by a quartz microbalance. The deposition rate was set to 1.0 Å/s (i.e. around 5·10¹⁵ atoms/s/cm²). The resulting film thickness was around 100 nm.

A collector 5 under the form of a Si wafer comprising a thin film, obtained as described above, was introduced into the sputter-deposition chamber 14 equipped with the FLIG. The sample 3 under analysis was a Ge wafer. It was sputtered by an O₂⁺ ion beam at 10 keV, with a beam current of 50 nA and with a spot diameter of 60 μm under ultra-high vacuum (base pressure <10⁻⁸ mbar). The raster size was 150×150 μm². The sputtered matter 2 was deposited on the collector 5, which was rotating continuously during the deposition process in order to obtain a sub-monolayer deposition level as the flux of sputtered matter 2 constantly deposits on virgin collector areas. The sample 3 and the limiting aperture 9 were immobile during the sputter-deposition.

The amount of sputtered Ge atoms has been calculated from profilometry measurements of the crater generated during the sputtering of the Ge sample. Considering the bombardment time and the speed of rotation of the collector 5, one can deduce that the number of sputtered Ge atoms per deposit ranges between 4.0·10¹³ and 4.5·10¹³ atoms for the different experiments.

The collector 5 with the sputtered Ge was introduced into the portable UHV suitcase (base pressure <10⁻⁸ mbar) and transferred to the SIMS instrument. The SIMS measurements were performed in a Cameca SC-Ultra instrument. A Cs⁺ primary ion beam with an impact energy of 560 eV and an incidence angle of 48° was used. The primary current was 20 nA and the raster size 500×500 μm². The analysis was performed in negative secondary ion mode (detection of Ge⁻).

For each collector 5, SIMS depth profiles have been performed on the Ge deposit 6. The amount of detected Ge has been calculated for each collector 5 by integration of the Ge signal after background subtraction. The useful yield UY of the method according to the invention for Ge can be calculated for each collector 5 by dividing the obtained total Ge⁻ counts by the number of Ge atoms initially sputtered from the Ge sample.

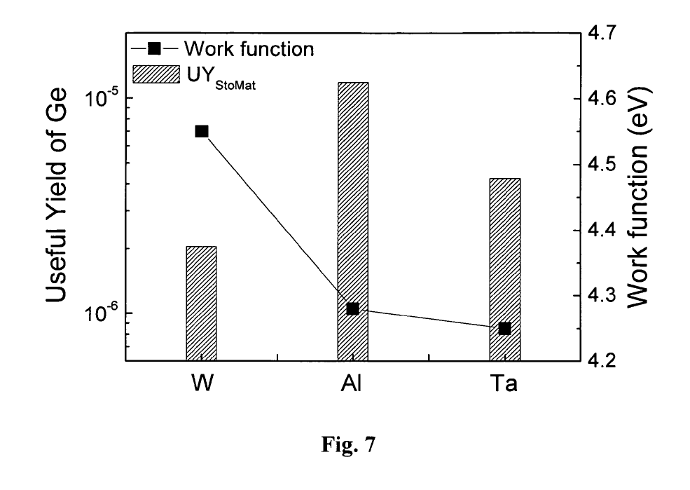

FIG. 7 shows the obtained values of UY for Ge (in the negative secondary ion mode) as a function of the material of the metallic collectors. The highest useful yield with 1.2×10⁻⁵ is found for the Al collector. For Ta, a value of 4.2×10⁻⁶ is obtained. For W finally, UY decreases to 2.0×10⁻⁶.

According to equation 1, the useful yield of the method according to the invention is composed of the collection efficiency γ and the useful yield of the SIMS analysis of the collector, UY_{SIMS}. The SIMS useful yield for monoatomic ions is only depending on an instrumental factor and on the ionisation probability of the considered secondary ion. Possible fluctuations of the instrumental factor have been eliminated in the present case by normalising the detected signals with respect to the bulk Si⁻ signal. The behaviour of the ionisation probability can be modelled in the present case (metallic collectors) by the electron-tunnelling model. This model basically considers that there is a dependency between the secondary ionisation probability (β) and the work function of the matrix (φ). For negative ionisation, the model predicts:

β⁻≈1 if φ<A, (Equ. 2a)

β⁻∝e^{-(φ-A)} if φ>A, (Equ. 2b)

where A is the electron affinity of the element to be ionised.

According to this model, the negative ionisation probability and thus the useful yield is increasing when the work function of the matrix φ is lowered.

The useful yield values obtained are in agreement with this model: the lowest useful yield is found for the collector with the highest work function (tungsten, Φ_{W}=4.55 eV), while two and six times higher values are obtained for lower work function collectors (tantalum, Φ_{Ta}=4.25 eV, and aluminium Φ_{Al}=4.28 eV, respectively).

It is known so far from experimental results and simulations that, depending on the angular distribution of the emitted particles, 10 to 40% of the sputtered particles are hitting the collector 5 on the 500 μm field which is analysed in the subsequent SIMS analysis.

A traditional direct SIMS analysis of a Ge Φ_{Ge}=5.0 eV) with a Cs⁺ primary ion bombardment and a detection of Ge⁻ secondary ions leads to a SIMS useful yield of 8.6·10⁻⁶. This value is in the range of the useful yields obtained by the technique according to this invention. One can thus conclude that, in the method according to the invention, the loss of matter during the sputter deposition process (γ<1) can be compensated, or even overcome, by high useful yields in the subsequent analysis of the collector thanks to optimised work function conditions of the collector coating.

### Example 2

### Inorganic Sample

Aluminum, titanium, indium and nickel samples have been analysed in the same way than described in example 1. The samples 3 have been submitted to a Xe⁺ sputtering ion bombardment 1. The emitted matter 2 has been collected on Si collectors 5.

The collectors 5 have been subsequently transferred under UHV conditions to a Cameca SC Ultra instrument and analysed by dynamic SIMS in the positive secondary ion mode.

The following useful yields UY of the method according to the invention have been determined:
UY (Al)=1.8·10⁻⁴
UY (Ti)=6.3·10⁻⁶
UY (In)=3.5·10⁻⁵
UY (Ni)=6.4·10⁻⁶

### Example 3

### Organic Sample

A silicon substrate coated with polyvinylchloride (PVC) is analysed.

The substrate is coated with polyvinylchloride by spin-coating performed with a KW-4A instrument from CHEMAT, allowing a two-step rotation with adjustable speed and time. A 2% wt PVC solution in THF is dropped on the substrates after heating in ultrasonic bath for dissolution. Then, the sample rotation is started at a speed of 700 rpm to spread it off and eliminate excess. Afterwards, the speed is raised to 2500 rpm to dry and homogenize the coating. Finally, the sample is annealed on a hotplate at 50° C. for about 30 minutes.

The collector 5, a one inch Silicon wafer, is cleaned in a ultrasonic bath with isopropanol and acetone, then is dried under a nitrogen flow and finally annealed on a hotplate to desorb remaining solvents.

The cleaned collector 5 is then coated with a gold layer for enhancing secondary ion emission. The gold coating is performed in a Molecular Beam Epitaxy (MBE) chamber 13 to obtain a coating of 1.8 nm.

The collector 5, under the form of a Si wafer comprising a thin film as described, was introduced into a sputter-deposition chamber 14 equipped with the FLIG. The PVC sample under analysis was sputtered by an Ar⁺ ion beam at 12.5 keV, with a beam current of 200 pA under ultra-high vacuum (base pressure <10⁻⁸ mbar). The raster size was 500×500 μm². The total primary ion dose was 5·10¹² ions/cm², which allowed to stay in the static conditions (ion dose <10¹³ ions/cm²).

In this analysis the collector 5 stays fix while the organic sample 3 is moved laterally, and back and forth, under the incident ion beam to multiply the sputtered zones on the samples. The collector 5 can then receive a larger dose (and thus a larger amount of sputtered matter). A matrix of 7×7 zones is sputtered into the sample of interest.

The organic deposited matter 6 on the collector plate 5 is then analysed by static SIMS (TOF-SIMS) on a IONTOF ToF-SIMS III instrument. The primary ion beam of Ar⁺ has an energy of 10 keV and a primary current of 1 pA. The pulse width is 500 ns, the repetition rate is 150 μs and the raster size is of 80×80 μm². The analysis is performed during 180 s in a negative and positive secondary ion mode.

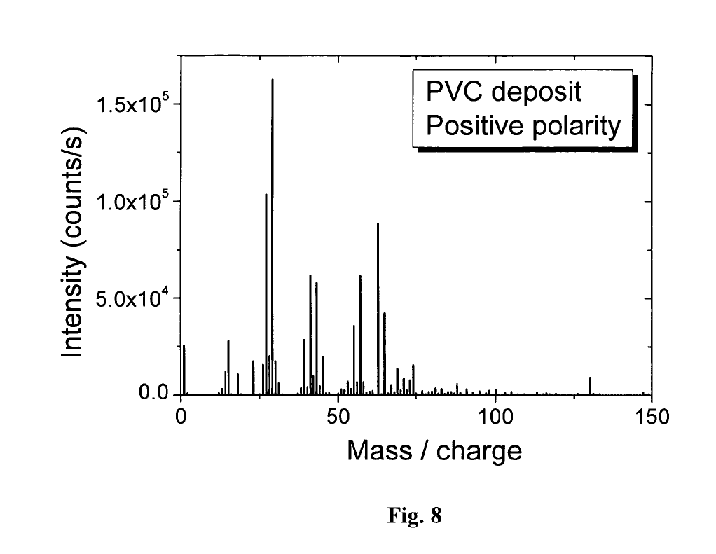

FIG. 8 shows the mass spectrum obtained in the positive secondary ion mode on the collected material 6 deposited on the collector plate 5. The characteristic peaks of PVC are enhanced due to the presence of the gold coating on the collector surface 5.

### Example 4

### Organic Sample

A silicon substrate coated with polystyrene (PS) is prepared and analysed as described in example 3. The analysis of the deposited matter 6 on the collector 5 is performed in the conditions described in example 2.

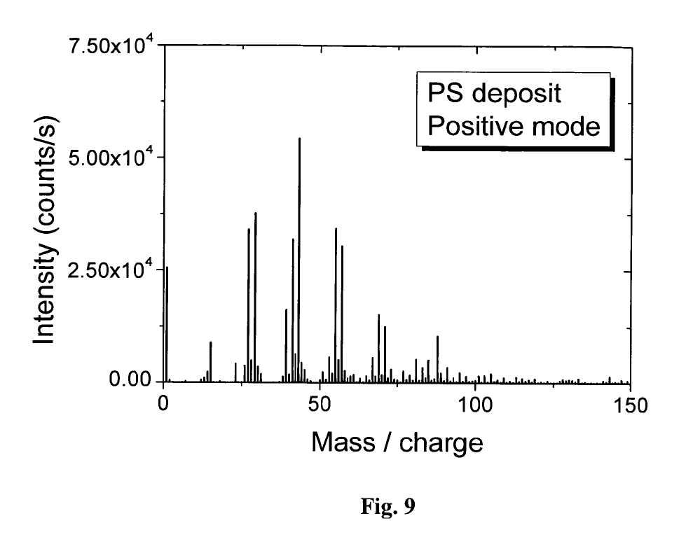

FIG. 9 shows the mass spectrum obtained in the positive secondary ion mode on the collected material 6 deposited on the collector plate 5. The characteristic peaks of PS are enhanced due to the presence of the gold coating on the collector surface 5.

1-17. (canceled)

18. A method for analysing an inorganic or organic sample under ultra-high vacuum, comprising the steps of:
a) providing under ultra-high vacuum at least one sample to be analysed,
b) providing under ultra-high vacuum at least one collector,
c) submitting said sample to an ion or neutral bombardment,
d) collecting on said collector particles emitted by said bombarded sample,
e) analysing the collected particles on said at least one collector,
said steps being performed so that the emission of sample particles is decoupled of the analysis step, and wherein the collector, the sample, or both, are moving independently one from the other during steps c) and/or d).

19. The method according to claim 18, further comprising, before step c), a cleaning step of the collector performed by an etching ion gun, operated with noble gas ions, cluster ions, metallic ions or neutrals.

20. The method according to claim 18, further comprising, before step c), a step of treating the collector, said treating step comprising either the oxidation, or the coating, or both, of the surface of the collector.

21. The method according to claim 20, wherein the surface of the collector is either oxydized, or coated with a layer made of one or more elements, or both, said elements being selected from the group consisting of aluminum (Al), arsenic (As), barium (Ba), beryllium (Be), bismuth (Bi), cadmium (Cd), caesium (Cs), calcium (Ca), carbon (C), cerium (Ce), cobalt (Co), copper (Cu), gadolinium (Gd), gallium (Ga), germanium (Ge), gold (Au), hafnium (Hf), indium (In), iridium (Ir), lanthanum (La), lead (Pb), lithium (Li), lutetium (Lu), manganese (Mn), magnesium (Mg), molybdenum (Mo), neodymium (Nd), nickel (Ni), osmium (Os), palladium (Pd), platinum (Pt), potassium (K), rhenium (Re), rhodium (Rh), rubidium (Rb) ruthenium (Ru), samarium (Sa), scandium (Sc), silicon (Si), silver (Ag), sodium (Na), strontium (Sr), tantalum (Ta), tellurium (Te), terbium (Tb), thallium (Tl), thorium (Th), tungsten (W), uranium (U), yttrium (Y), and zirconium (Zr).

22. The method according to claim 20, wherein the treating step of the collector is performed by Physical Vapor Deposition (PVD), Electron Beam Physical Vapor Deposition (EBPVD), Molecular Beam Epitaxy (MBE) or Rapid Thermal Processing (RTP).

23. The method according to claim 18, wherein the collector is made of an organic material or a metal or a semi-conductor material.

24. The method according to claim 18, wherein the ion bombardment is a monoatomic ions, a cluster ions bombardment or neutral bombardment.

25. The method according to claim 18, wherein a first analytical instrument used to perform step c) and d), and a second analytical instrument used to perform step e), are located in remote places.

26. The method according to claim 18, wherein step e) is performed by an analytical method selected from the group consisting of static SIMS (Secondary Ion Mass Spectrometry), dynamic SIMS, LEIS (Low-Energy Ion Scattering), RBS (Rutherford Back Scattering), XPS (X-ray Photoelectron Spectroscopy), AES (Auger Electron Spectroscopy), UPS (Ultraviolet Photoelectron Spectroscopy), electron microprobe, and Total X-Ray Fluorescence.

27. An analytical instrument operating under ultra-high vacuum wherein it comprises at least one collector for collecting the secondary particles emitted during an ion or neutral bombardment of a sample to be analysed and in that said collector, the sample, or both, are movable in any direction, independently one from the other.

28. The instrument according to claim 27, wherein a diaphragm with a circular aperture is disposed in front of the collector, preferably at a distance of about 2 mm from the collector, so that to limit the exposed surface of the collector to the particles emitted from the sample, preferably to a diameter of 500 μm.

29. The instrument according to claim 27, wherein the collector comprises a one inch wafer made of an organic material, or a metal or a semi-conductor material.

30. The instrument according to claim 27, wherein it is provided with means for either oxydizing, or coating with a layer made of one or more elements, the surface of the collector, or both, said elements being selected from the group consisting of aluminum (Al), arsenic (As), barium (Ba), beryllium (Be), bismuth (Bi), cadmium (Cd), caesium (Cs), calcium (Ca), carbon (C), cerium (Ce), cobalt (Co), copper (Cu), gadolinium (Gd), gallium (Ga), germanium (Ge), gold (Au), hafnium (Hf), indium (In), iridium (Ir), lanthanum (La), lead (Pb), lithium (Li), lutetium (Lu), manganese (Mn), magnesium (Mg), molybdenum (Mo), neodymium (Nd), nickel (Ni), osmium (Os), palladium (Pd), platinum (Pt), potassium (K), rhenium (Re), rhodium (Rh), rubidium (Rb) ruthenium (Ru), samarium (Sa), scandium (Sc), silicon (Si), silver (Ag), sodium (Na), strontium (Sr), tantalum (Ta), tellurium (Te), terbium (Tb), thallium (Tl), thorium (Th), tungsten (W), uranium (U), yttrium (Y), and zirconium (Zr).

31. The instrument according to claim 27, further comprising analytical means selected in the group consisting of static SIMS (Secondary Ion Mass Spectrometry), dynamic SIMS, LEIS (Low-Energy Ion Scattering), RBS (Rutherford Back Scattering), XPS (X-ray Photoelectron Spectroscopy), AES (Auger Electron Spectroscopy), UPS (Ultraviolet Photoelectron Spectroscopy), electron microprobe, and Total X-Ray Fluorescence.

32. The instrument according to claim 27, further comprising the following main sections, all under ultra-high vacuum:
optionally, a docking station or chamber, able to fit a transfer vessel for transferring the collector, possibly mounted on a holder, between the instrument and said transfer vessel;
a cleaning section for cleaning the collector, preferably equipped with a sputter gun allowing ion etching;
a coating and preparation section, for preparing and surface oxydising and coating the collector, preferably equipped with effusion cells, an electron beam evaporator, quartz microbalances, a Reflection High Energy Electron Diffraction (RHEED) and/or a Residual Gas Analyser (RGA);
a sputter-deposition section for sputtering the sample and further depositing the sputtered particles onto the collector, equipped with an ion gun, preferably being of the Floating Low-Energy Ion Gun (FLIG) type, a secondary electron detector allowing a visualization of the sputtering ion beam and two motorized high precision stages for the sample and the collector respectively;
the transfer of the collector between the different sections being made using handling means and a transfer tube connected under ultra-high vacuum to all said sections.

33. The instrument according to claim 32, further comprising an analysis section, for analysing the material collected on the collector surface.
